(19) United States
(12) Patent Application Publication
(10) Pub. No.: US 2022/0101430 A1
(43) Pub. Date: Mar. 31, 2022

(54) Blockchain-Based Carbon Credit Database

(71) Applicant: Benny M. Barton, Dallas, TX (US)

(72) Inventor: Benny M. Barton, Dallas, TX (US)

(21) Appl. No.: 17/484,787

(22) Filed: Sep. 24, 2021

Related U.S. Application Data
(60) Provisional application No. 63/083,605, filed on Sep. 25, 2020.

(51) Int. Cl. G06Q 40/04; G06Q 30/00; G06Q 50/02; G06Q 20/38; G06F 16/29; E21B 49/08; E21B 41/00

(52) U.S. Cl. CPC G06Q 40/04; G06Q 30/018; G06Q 50/02; G06Q 50/26; G06F 16/29; E21B 49/087; E21B 41/00; G06Q 20/389

(57) ABSTRACT

Systems and methods are described for a blockchain-based carbon credit database. Mineral deposits (such as hydrocarbons) can be analyzed via a variety of regulatorily or NGO approved methods to determine size, type and other characteristics. The deposit, depending on one or more of its features, can then be converted into carbon credits (assuming said deposits are not accessed) and associated with a node on a blockchain. The carbon credits can then be traded on the blockchain.

### TECHNICAL FIELD

The present disclosure relates to the carbon credits generated from oil and gas sequestration, and more specifically to blockchain-based carbon credit creation, manufacturing, valuation, registration, and ownership tracking.

### BACKGROUND OF THE INVENTION

Various countries and American states have systems in place for the creation and selling and trading of carbon credits or other type of pollution credits. In general, these programs reward environmentally friendly actions (e.g., not burning fuel, not mining certain materials, planting trees) with a credit allowing for the burning of a fossil fuel. A beneficiary of a credit can sell it to a business that depends on the burning of fossil fuels. As a result, a market is created for carbon credits. Some credits can be based on fossil fuels, hydrocarbon reserves or unconventional hydrocarbon resources.

It can be difficult to track and to verify carbon credits to ensure that the credit is valid and that it has not been previously sold to an entity still using the credit. What is needed is a secure system and method for creating, validating, and tracking carbon credits.

### BRIEF SUMMARY OF THE INVENTION

One embodiment under the present disclosure comprises a system for converting hydrocarbon bearing mineral deposits to carbon offset credits and allowing for the trading of such carbon offset credits. The system includes a database configured to receive location and valorization information regarding hydrocarbon bearing mineral deposits, where the database configured to maintain a map of all record mineral deposits. The database is further configured to verify mineral deposits with a creator of carbon credits and to assign respective carbon credits to a mineral deposit. A blockchain configured to allow nodes to trade the carbon offsets associated with the hydrocarbon bearing mineral deposits. The database is further configured to associate a mineral deposit with a node of the blockchain, and further configured to update the map when a mineral deposit is traded to a new owner.

Another embodiment under the present disclosure comprises a method of creating and trading carbon credits. The method includes performing an analysis of a hydrocarbon deposit comprising determining a size and a production risk value. Independent party certification is obtained of the analysis and the hydrocarbon deposit is converted into registered carbon credits. The registered carbon credits are then associated with one or more nodes on a blockchain, and the trading of the carbon credits is then allowed via the blockchain.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawings, in which:

FIG. 1 shows a table of greenhouse gas emissions by oil type.

FIG. 2 shows an embodiment of a valuation of a mineral deposit.

FIG. 3a shows oil resource definitions.

FIG. 3b shows UNFC Classifications for Known Resources and Sub-classes.

FIG. 4 shows a blockchain system embodiment under the present disclosure.

FIG. 5 shows a blockchain record embodiment of a mineral deposit under the present disclosure.

FIG. 6 shows a method embodiment under the present disclosure.

FIG. 7 shows an example of a calculation of original oil in place for an example mineral deposit.

FIG. 8 shows a table embodiment of properties of a mineral deposit.

FIG. 9 is an embodiment of a computing environment for use in the present disclosure.

FIG. 10 is an embodiment of a cloud computing system for use in the present disclosure.

FIG. 11 is an embodiment of a system for creating and managing a block chain object.

### DETAILED DESCRIPTION OF THE INVENTION

One embodiment under the present disclosure is a blockchain-based system for validation, marketing, and ownership of carbon credits. To facilitate such trading, another embodiment under the present disclosure is a system for converting mineral deposits into carbon credits. Carbon credits often come from efforts that reduce the burning of fossil fuels, or actions like planting trees to offset already produced carbon. Another source can be found in untapped mineral deposits with fossil fuels. But converting such deposits into carbon credits is not easy. Embodiments under the present disclosure include blockchain-based systems and methods for the trading, selling and valorization of carbon credits. Further embodiments under the present disclosure comprise blockchain tools and systems for converting mineral deposits to carbon credits.

Carbon credits are generated from projects around the world that pull Greenhouse Gases (GHGs) out of the atmosphere or keep them from ever entering the atmosphere. Each time a project verifies they have reduced, avoided, or destroyed one metric tonne of GHGs, one carbon credit is created. A carbon credit is a registered and tradable permit or certificate that provides the holder of the credit the right to emit one tonne of carbon dioxide or an equivalent of another greenhouse gas. The credit is essentially an offset for producers of greenhouse gases. One source of carbon credits is carbon bearing mineral deposits contained in ancient carbon sinks. Delaying or refusing to dig up these deposits can result in carbon credits for the deposit owner, in some jurisdictions.

Carbon trading is the buying and selling of the right to emit a tonne of CO² or equivalent (CO²e). The right to emit a tonne of CO′ is often referred to as a carbon ‘credit’ or carbon ‘allowance’. For example, in the EU Emissions Trading Scheme there is the EU Allowance (EUA) and in the California system there is the California Carbon Allowance (CCA). The allowances of each trading system can be bought and sold by anyone but, ultimately, they may reach end-users when they need them to cover their regulatory compliance obligations. Voluntary Carbon Credits are traded in a similar manner after being certified by an Independent Professional Non-Governmental Organization which are often referred to as a NGO.

Allowances could exist in paper form much like share certificates, however for efficiency they exist purely in digital form and are held in electronic ‘registry’ accounts, much like an internet banking system. The registry accounts in compliance systems are run by the regulator of that system to maintain integrity. While voluntary credits are accounted for in registries managed by NGO's.

The actual trading of carbon allowances is much like the trading of any other commodity. Futures exchanges exist to facilitate spot and longer dated deliveries plus options. The same trades can take place ‘over the counter’ (i.e., bilaterally) between two willing counterparties and often involve carbon brokers acting as introducers or as an intermediary counterparty. Voluntary credits most often traded in an over-the-counter method with a NGO acting as a clearing party registering trades on their respective registries.

Verification of carbon credits or other offsets is done differently in different jurisdictions or systems and governed by the rules and regulations of the issuing NGO. For example, The American Carbon Registry (ACR), a NGO, requires independent third-party validation and verification of all voluntary carbon offset projects following the ACR Validation and Verification Standard. Validation and verification are risk-based processes carried out in conformance with ISO 14064-3:2006, ISO 14065:2013 and ISO 14044:2006. ACR validation and verification bodies (VVBs) are accredited for project validation and verification and the scope of the applicable methodology, and VVB teams likely have to meet the competence requirements as set out in ISO 14065:2013, ISO 14066:2011 and ISO 14044:2006.

ACR requires that all ACR-approved VVBs execute an Attestation of Validation/Verification Body, which defines the VVB role and responsibilities and confirms technical capabilities and no conflicts of interest with ACR. ACR-approved VVBs must also execute a Project-Specific Conflict of Interest Form for each project validated and/or reporting period verified. Validation and verification activities must address all program requirements listed in the American Carbon Registry Standard and follow the requirements of the ACR Validation and Verification Standard. Projects must be verified without reservation, with project proponents having addressed all clarifications and corrections required by the VVB.

Once ACR reviews and accepts a verification statement, and the project proponent has completed all other required steps, ACR will post the verification report, verification statement, and other documentation to the public ACR website, and issue serialized ERTs to the project proponent's account.

California AB 32 requires regulatory verification of all GHG reductions and removal enhancements used for compliance in the Cap-and-Trade Program. The Cap-and-Trade Regulation includes requirements that verification bodies and offset verifiers must meet to be accredited by ARB to conduct regulatory verification.

The U.N. approval of carbon offsets is basically a five-step process. First, after investors identify a prospective project, they hire a Department of Energy (DOE) approved entity to assess the reduction of emissions. Second, the entity then puts together a report that includes estimates of both existing greenhouse-gas release rates and the potential for reduction given different technological approaches. Third, that report is then submitted to the U.N. Executive Board, which audits it before passing judgment. Fourth, once approved, the project is considered “validated” and the prospective credits can be placed on the market as a sort of futures contract: the credits can be bought and sold, but buyers who need credits to meet their caps do not actually receive them yet. Delivery happens months or even years later, after a separate entity is brought in again to “verify” that the promised emissions reductions have occurred. Fifth, upon verification, the credits are called Certified Emission Reductions (CERs) and can be used by purchasers against their caps. The projects' emission reduction credits will provide various ranges of consumer and industry emissions credits which range from Voluntary through Certified Emission Credits.

The Accounting Standards Codification (ASC) 932 is the SEC's standardized measure of oil and gas. The ASC requires public companies to disclose their crude oil and natural gas reserves using a standardized measurement. The process includes several steps: First, petroleum engineers and qualified petroleum professionals make estimates based on the amount of proved, probable and possible reserves. Third party audits of estimates provide validity for company reserves. The United Nations Framework Classification for Resources (UNFC) Updated 2019 provides a granular detail for Fossil Energy and Mineral Reserves and Resources 2009 incorporating Specifications for its Application (ECE Energy Series 42 and ECE/ENERGY/94) that was issued at the end of 2013. The updated version of UNFC is intended to satisfy the requirements of different resource sectors and applications, as well as making it fully aligned to the sustainable resource management called for by the 2030 Agenda for Sustainable Development. The key changes, including the normalization of the text, make UNFC applicable for all resources.

Fair market value is the valuation for tax purposes under the U.S. Internal Revenue Code. FMV takes into consideration what market participants expect in return for selling their business or assets, and it includes assumed capital structure, tax rates and synergies. Conversely, the SEC reported value is the crude oil and natural gas reserve valuation that companies disclose to the SEC. The United Nations Framework Classification for Resources (UNFC) is a resource project-based and principles-based classification system for defining the environmental-socio-economic viability and technical feasibility of projects to develop resources. UNFC provides a consistent framework to describe the level of confidence of the future quantities produced by the project which allows efficient market value estimates for viable and potentially viable projects.

Carbon credits must follow the principal of additionality. Additionality includes three concepts: Emission Additionality, Financial Additionality, and Technology Additionality.

Selecting mineral deposits under the present disclosure can be done in several steps. Deposits should have “additionality” meaning mineral deposit quantities should not be classified viable or potentially viable unless there is an expectation that the accumulation will be developed and placed on production or engaged in a capture activity within a reasonable timeframe. They also should be under the exclusive claim of an owner/issuer so that deposits are not double counted under two owners. As such, ownership title to the deposits should be verified using industry standards.

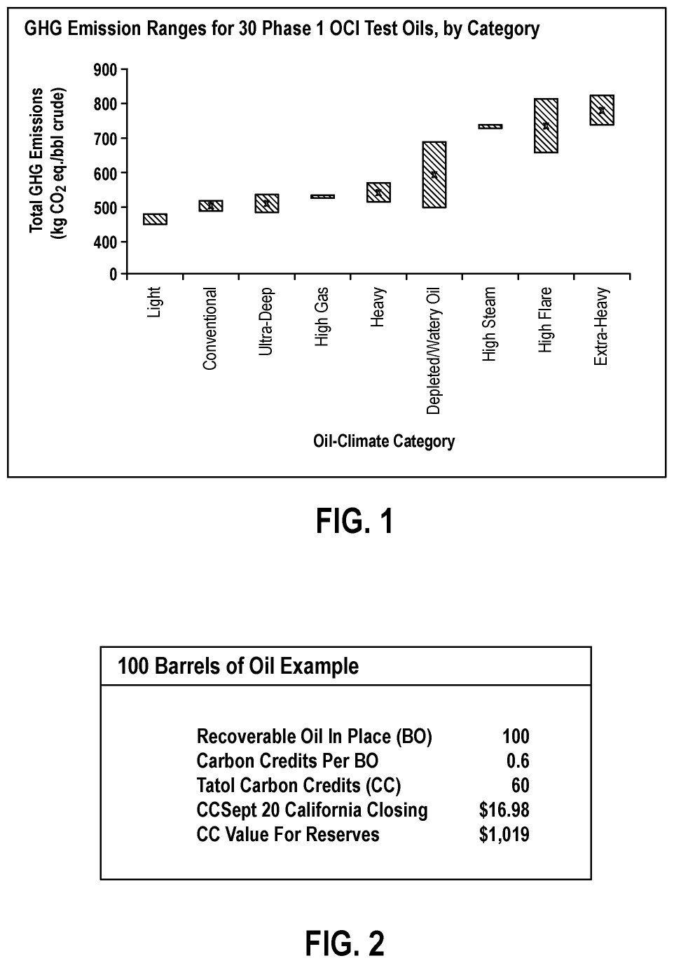

Oil CO2 emissions credit values or carbon credits are distinctive to the type of oil. FIG. 1 shows an example of different total greenhouse gas emissions for different types of oil. Accordingly, different credit values attach to each type of deposit and the resulting conversion of barrels of oil to tonne of CO2 is variable based on the type of type or mix of oil types in the deposit. Life Cycle Assessment (LCA) defined ISO 14044:2006 allows for allocation of upstream, mid-stream and downstream emissions of fossil fuels.

FIG. 2 displays an example valuation of a hydrocarbon deposit under the present disclosure. In this case, the deposit has 100 barrels of oil with a 0.6 (60/100) LCA conversion ratio of carbon to oil type thus yielding the CO2 equivalent of 60 tonnes when marketed at a price of $16.98 per tonne the market value of the 100 barrels of hydrocarbon being $1,018.

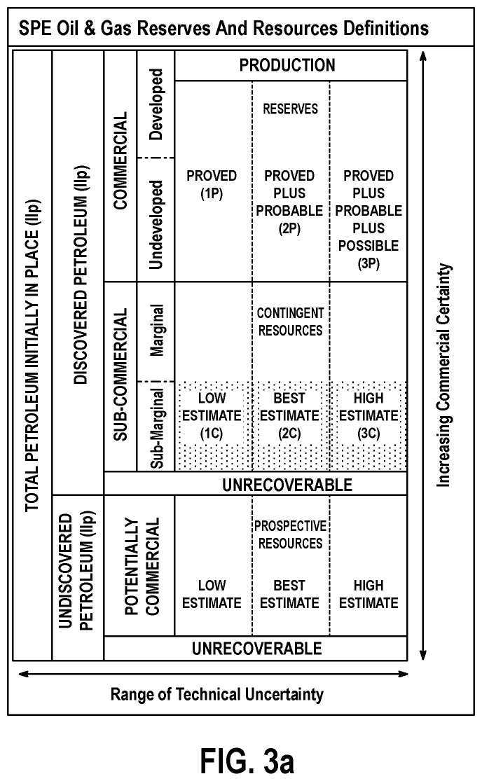

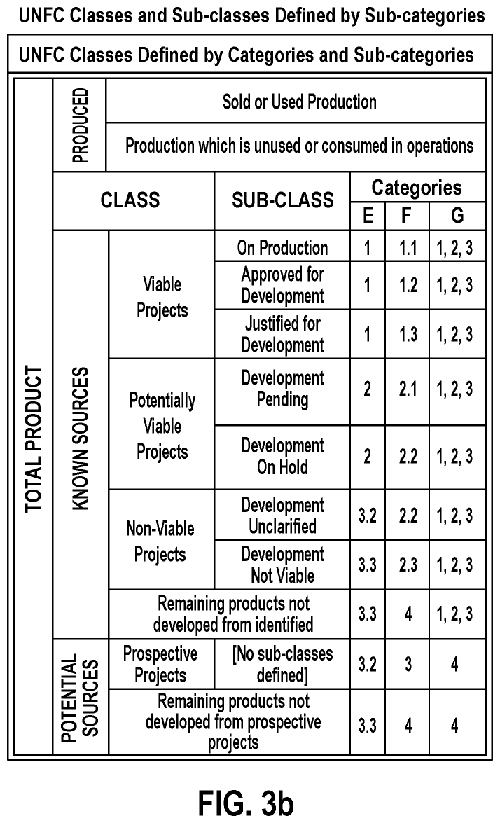

Mineral deposits fall under different levels of probability, or proof of the capability of being extracted. For an oil or gas deposit to be classified as “reserves,” technical and commercial certainty of extraction using existing technology must be established. Once established, the degree of this certainty is then decided, breaking reserves down into three distinct categories: Proved Reserves, Probable Reserves, and Possible Reserves. The term ‘3P reserves’ refers to the combination of all three of these totals, i.e., Proved plus Probable plus Possible. FIGS. 3a and 3b shows examples of a detailed breakdowns regarding the classifications of oil and gas reserves. The United Nations Framework Classification for Resources (UNFC) is a universally acceptable and internationally applicable resource project-based and principles-based classification system for defining the environmental-socio-economic viability and technical feasibility and maturity of projects to develop resources. UNFC provides a consistent framework to describe the level of confidence of the future quantities produced by the project. The importance of environmental and social issues in the context of resource classification is recognized as a part of commerciality.

Embodiments under the present disclosure can include a blockchain-based registry database for mineral deposits that also comprise mapping of the listed mineral deposits. Mapping can comprise ArcGis-based mapping, or any other appropriate mapping technology. Sources of data and means of data collection include the Oil Climate Index (OCI) a LCA, the Oil Production Greenhouse Gas (GHG) Emissions Estimator (OPGEE), the Petroleum Refinery Life-Cycle Inventory Model (PRELIM), and the Oil Products Emissions Module (OPEM). Data for these analyses can include oil samples, drilling and completion techniques, workovers, Primary, Secondary, or Tertiary Recovery analyses, transportation means and distances.

Preferred embodiments under the present disclosure can include a blockchain-based registry database for the new carbonless mineral deeds. Assigning and/or recording new mineral deeds in after the carbon minerals are permanently converted to carbon credits ensures the GHG producing deposits will remain in the ground and unproduced.

In preferred embodiments under the present disclosure a mineral deposit can be analyzed to determine its hydrocarbon resources and their accessibility. Verification and audit can then be performed according to an official protocol, such as listed above (GIS mapping, OCI analysis, etc.), or as otherwise set forth by a governing authority. A verified hydrocarbon deposit can then be listed on a blockchain. A blockchain under the present disclosure can include Bitcoin, Ethereum, and other similar private or publicly accessible blockchains or distributed ledger technologies (DLT) including NFT's. The term blockchain is used in the present disclosure, but reference is also intended to various types of DLTs that may not fit a precise definition of a blockchain.

Once hydrocarbons or other mineral deposits are listed on the blockchain the blockchain can provide a transfer tool and repository. Making the blockchain publicly available can allow the public and users to view available carbon credits and, if desired, characteristics, price and other information.

A preferred definition of a blockchain is a public ledger of all transactions of a blockchain-based currency. One or more computing devices may comprise a blockchain network, which may be configured to process and record transactions as part of a block in the blockchain. Once a block is completed, the block is added to the blockchain, and the transaction record thereby updated. In many instances, the blockchain may be a ledger of transactions in chronological order or may be presented in any other order that may be suitable for use by the blockchain network. In some configurations, transactions recorded in the blockchain may include a destination address and a currency amount, such that the blockchain records how much currency is attributable to a specific address. In some instances, additional information may be captured, such as a source address, timestamp, etc. In some embodiments, a blockchain may also consist of additional, and in some instances arbitrary, data that is confirmed and validated by the blockchain network through proof of work and/or any other suitable verification techniques associated therewith. In some cases, such data may be included in the blockchain as part of transactions, such as included in additional data appended to transaction data. In some instances, the inclusion of such data in a blockchain may constitute a transaction. In such instances, a blockchain may not be directly associated with a specific digital, virtual, fiat, or other type of currency. A blockchain ledger may be unalterable without detection. For example, each block may include a data header that includes a hash of the previous block in the blockchain ledger and a root value of all past transactions. Since each block in the blockchain ledger may be generated in a similar manner by including a data header storing information referencing its previous entry and previous transactions, no entry can be modified without affecting all following entries. This ensures that any tampering of information related to transactions, such as an attempt to reassign a digital asset to an inappropriate entity, will not go unnoticed.

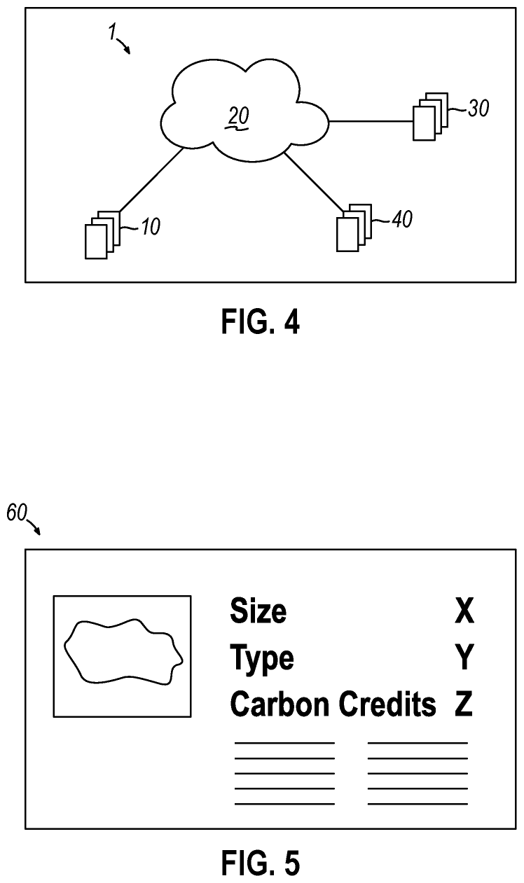

As discussed in more detail below, an embodiment of a blockchain system 1 of FIG. 4 may include blockchain network 20 which may comprise nodes 10 and 30 and optional registry database or administrative node 40. The blockchain network 20 may be a network configured to store a blockchain, which may be a ledger of electronic transactions that may include record of guaranteed payments. In such instances, the payment or transaction data may include identifiers associated nodes 10, 30 and public keys or destination addresses associated with the transmission of guaranteed payments associated with verified mineral deposits.

Embodiments under the present disclosure may include public or private blockchains. Private blockchains may have a central database capable of exerting greater control over the blockchain than in public or distributed blockchains. Public or distributed blockchains allow any new user to form a node on the blockchain.

In some situations, node 10 may own or be associated with a mineral deposit. Node 10's account on blockchain network 20 may be recognized or be previously demonstrated to own the mineral deposit and/or the carbon credits associated with the deposit. Node 10 may desire to sell the carbon credits to node 30. An offer can be sent by either node 10, 30 to the other. Upon acceptance the sale of the carbon credits can be initiated. In some embodiments node 10 (the seller) may generate a blockchain transaction as the record of payment guarantee. The blockchain transaction may be a transaction for payment of the transaction amount stored in the corresponding node 30. Methods for the generation of a blockchain destination address using a public key will be apparent to persons having skill in the relevant art. The node 10 may then electronically transmit the generated blockchain transaction to the blockchain network 10, node 30, or a computing node associated therewith for posting to the blockchain. A history of all transactions is preferably stored at each node in the network. However, embodiments are possible where there is a central repository that maintains control and a history over all transactions. Node 10 may receive the funds for the payment transaction via the blockchain, which may be in the form of a blockchain currency or a fiat currency. In some cases, the blockchain transaction may be used to convey the record of guaranteed payment.

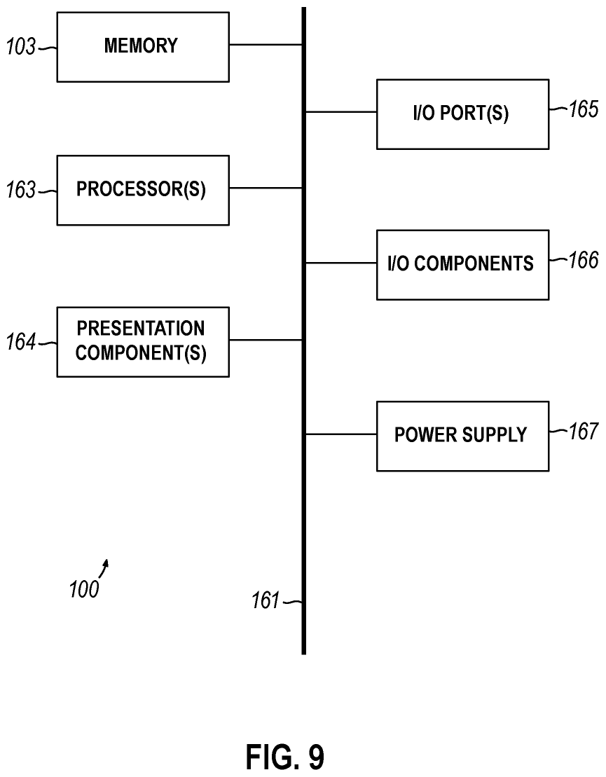

As discussed further with reference to FIGS. 9 through 11, a node of a blockchain under possible embodiments hereunder can comprise an apparatus comprising one or more processors and one or more non-transitory computer-readable memories coupled to the one or more processors and configured with instructions executable by the one or more processors to cause the system to perform operations comprising: determining a transaction amount to be remitted from a remitter's blockchain account into a receiver's blockchain account, wherein a balance of the remitter's blockchain account comprises a plurality of reserve balances, and a commitment of each of the plurality of reserve balances is recorded in a blockchain; selecting one or more of the plurality of reserve balances from the remitter's blockchain account, wherein the sum of the selected one or more of the plurality of reserve balances is not smaller than the transaction amount; and submitting to the blockchain a transaction comprising an identification of each of the selected one or more of the plurality of reserve balances and a commitment of the transaction amount, for the selected one or more of the plurality of reserve balances to be removed from the remitter's blockchain account and the transaction amount to be added to the receiver's blockchain account after the transaction is implemented.

In some embodiments, an update ledger module in a node may include instructions for maintaining a ledger of transactions in the form of a blockchain. For example, an update ledger module may be able to create and/or sign new blocks. A new block including one or more digital assets may be generated after an average time interval (e.g., every minute, ten minutes, 1 hour, etc.). Authenticity may be provided to a block via a digital signature. The node or administrator may optionally create a hash header for each block based on the digital assets in the block, a hash of a previous block, a nonce, a random number, and/or any other suitable information. A ledger, such as a blockchain ledger, may optionally be stored in a ledger database or administrative node 40. Additional databases may store transaction records (e.g., a list of transactions not in a blockchain) and/or invoice records. A blockchain system 1 or network 20 may also comprise a connection to, or servers that comprise part of, a regulatory registry account or system maintained by a regulator.

In some embodiments of the invention, the blockchain ledger may not be present on all nodes 10, 30 in a distributed network, but may be maintained by a secure administrative node computer or ledger database 40. Accordingly, computationally intensive features such as proofs of work may not be present or needed. In some embodiments, there may be multiple administrative node computers 40 that each receive transaction updates and update their own ledger. These different administrative node computers 40 may communicate with one another to confirm that their ledgers have the same transaction information.

Each transaction on the blockchain may comprise a mapped record of the location, ownership and issued carbon credit of the respective mineral deposit, such as in ArcGis formatting. Ledger database 40 may also comprise an ArcGis map of all deposits associated with the blockchain.

A sample record 60 of a carbon credit and associated mineral deposit can be seen in FIG. 5. An embodiment of a record such as this may be attached to a blockchain record and may be linked to the actual mineral deposit, either by the blockchain record itself, or by a database. The record may include a map of the location of the mineral deposit, as well as characteristics such as size, type, and associated carbon credits.

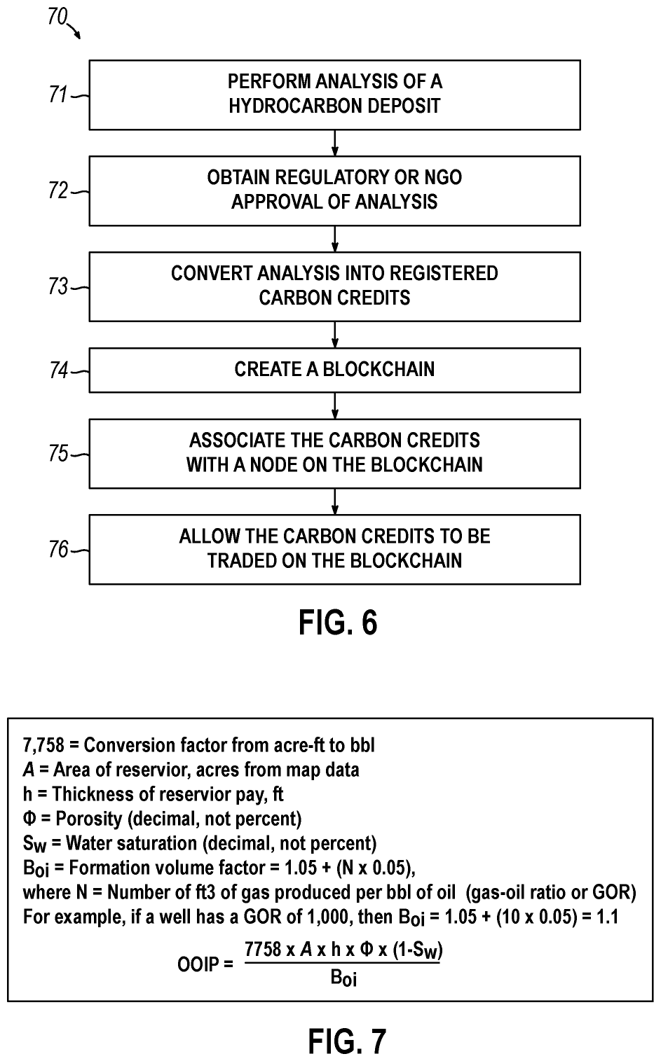

FIG. 6 displays a preferred embodiment of a method 70 under the present disclosure. At 71, an analysis is performed of a hydrocarbon deposit. The analysis can include size, Production Risk Value, or other characteristics as described above. At 72, regulatory approval is obtained of the analysis through an appropriate validation and verification process, or as otherwise set forth under the applicable cap and trade system. At 73, the analysis is converted into registered carbon credits. At 74, a blockchain is created (or a preexisting one can be used in other embodiments). At 75, the carbon credits can be associated with a node on the blockchain. Preferably the node is owned by the owner of the carbon credits. At 76, the carbon credits are allowed to be traded or otherwise sold on the blockchain.

The steps of method 70 can each include multiple sub-steps. For example, step 71 can include performing an ownership report (producing, leased and unleased), geographic referencing of the location, determining volume of recoverable fossil fuels sequestered using professional assessment of acreage with petroleum engineers, geologist, and petrophysics, and third-party verification of any of these steps. Determining who owns the fossil fuel asset being sequestered is the starting point of who has the legal right to the product and how payments for economic incentives are disbursed. Fee simple mineral title is the absolute ownership of all aspects of the mineral rights below the surface of the ground in perpetuity. The fee simple owner of minerals is the only party who may grant a “deeded” conservancy restriction delaying the development of fossil fuel accumulations. An oil company may have “leased” the rights to a portion of the produced product, however, they do not own the right to permanently modify the rights of a fee simple owner. Sequestering producing leased mineral interest will require “consent” of Lessee and a “grant” from the mineral owner. Nonproducing unleased mineral interest require only a grant from the fee simple mineral owner.

Further, under step 71, assessing the size of a deposit, and what types of deposits are available, can include multiple analyses. Petrophysics analysis combined with geoscientists, petroleum geologists, and reservoir engineering knowledge provides an industry approach to determine hydrocarbons in place and the potential expected volume to be extracted through development. Using known lithology, porosity, water saturation, permeability, and density values for a selected geologic interval can determine viable and potentially viable hydrocarbon volumes contained inside a specific land area. Resource evaluation and improved technology advances are responsible for the Permian Basin's increased daily production rate from 1 to 4 million barrels of oil in the past ten years. Calculations can begin with the estimation of the original oil-in-place (OOIP). Oil-in-place is also known as stock tank original oil-in-place (STOOIP) or stock tank oil-initially-in-place (STOUP), referring to the oil in place before the commencement of production. To calculate volume of original oil in place (OOIP) in barrels from volume measured in acre-feet, the formula shown in FIG. 7 can be used. Estimating recoverable oil or gas depends on predicting reservoir quality and reservoir drive. Reservoir analogs help narrow the range of values for variables that determine recovery factor (R.F.). The equation of FIG. 7 can be used to estimate the recoverable oil or gas in a reservoir: Recoverable oil or gas=OOIP times R.F. A 2016 publication from the U.S. Department of the Interior and the U.S. Geological Survey describing recovery factor percentages from multiple formations (Clastic and Carbonate) in the Permian Basin ranged from a minimum of 8.67% to a maximum of 26.92% with 1^{st} quartile values from 9.5% to 14.8%. Multiple scholarly reports suggest minimal recovery of 5%-9% of OOIP for resource formations located in the Permian Basin. The US Energy Information Administration (“EIA”) and the United Nations (“UN”) have developed internationally accepted categories and standards for “Known Resources” defining Technically Recoverable, Viable, and Potentially Viable Projects. Industry professionals using available geologic and engineering data can determine resource quantities stored in the subsurface. Reservoir characteristics, diversity of fluid analysis, and current extraction technologies determine the volume of producible oil and gas from a Known Resource reservoir.

Step 72 can include determining Life Cycle Assessment (LCA) using ISO 14040 and 14044:2006 guidelines or Oil Climate Index or other Professionally accepted LCA publications, and getting third party verification. Life Cycle Analysis (LCA) can be used to determine a possible volume of emissions ascribed to a deposit and is therefore useful in determining carbon offset credits. LCA of the recoverable oil in place is used to determine the equivalent volume of emissions derived from formulated recovery barrels of oil in place. The Oil ClimateProject and the Oil Climate Index provide an excellent scholarly work for understanding the conversion process (http://oci.carnegieendowment.org/#oil/u.s.-texas-yates).

Step 73 can include calculating a conversion ratio as determined by LCA, often by the Competent Person (U.N. defined) professional calculation ISO 14064 guidelines. Third-party verification may also be required. Step 730 can also include calculating tonnes of sequestered C02, often by assessing recoverable volume times LCA ratio, and by the Competent Person (U.N. defined) professional calculation. Third-party verification may be needed. Step 74 can include blockchain association of serial number to each tonne of CO2, by a Competent Person (U.N. defined) professional calculation and third-party verification. Step 75 can include implementation of DeFi Smart Contract governing transactions, such as by a law firm drafted document and third-party review of contract. Step 76 can include blockchain implementation and issuance of individual serialized DeFi contracts by a Competent Person (U.N. defined) professional tech company and third-party review process. Method 70 can include certification audit and review of these steps by a Competent Person (U.N. defined) Auditor. Marketing of the certified fossil fuel offsets can follow.

In another embodiment under the present disclosure, a verification methodology is used to analyze a mineral deposit and yield a value measured in metric tonnes of greenhouse gas per barrel of oil. The deposit could then be subjected to a valuation methodology with a result measured in barrels of oil. Multiplying the verification output by the valuation output gives an estimate of total CO2 in metric tonnes that could be released into the air in relation to the mineral deposit. This volume of CO2 in metric tonnes, could be given carbon credits at a ratio of 1:1, on credit for each metric tonne. Alternatively, a government, regulator, or other entity could apply a multiplier to adjust up or down the carbon credits.

To illustrate using a simplified example, a known mineral deposit, comprising carbon or hydrocarbons, is discovered under Arlington, Tex. A verification methodology is applied to the deposit, such as OCI. This methodology yields a value of 10 tonnes/barrel of oil of greenhouse gases. A valuation methodology is then applied to the deposit. In the USA, this will typically be the SEC standards, such as in FIG. 3. The deposit may have technically recoverable viable or potentially viable Proved, Probable and Possible portions. For the sake of simplicity, we will set Proved at 3.0, Probable at 1, and Possible at 0.1, all being viable or potentially viable as defined by UNECE. Multiplying the verification result by the valuation result will yield (10×3)+(10×1)+(10×0.1)=30+10+1=41 tonnes of CO2. In some situations, this may equal 41 carbon credits. A regulator or other entity may apply a multiplier, depending on how carbon credits based on mineral deposits are treated by law, industry, or the market. A multiplier could be 0.5, or 6, or any appropriate number depending on the assessed value of such credits. In these examples, the resulting carbon credits might be 20.5 (0.5×41) or 246 (41×6).

The sample deposit can then be tagged with geographic information, validated by a regulator or industry group, and placed on a blockchain by an entity such as the American Carbon Registry or Gold Standard. Preferably, a reference to a hydrocarbon conservancy deed would be included in the title part of the blockchain. In preferred embodiments a recordable instrument (such as the carbon deed) would also be filed with the county record office or other official physical registry.

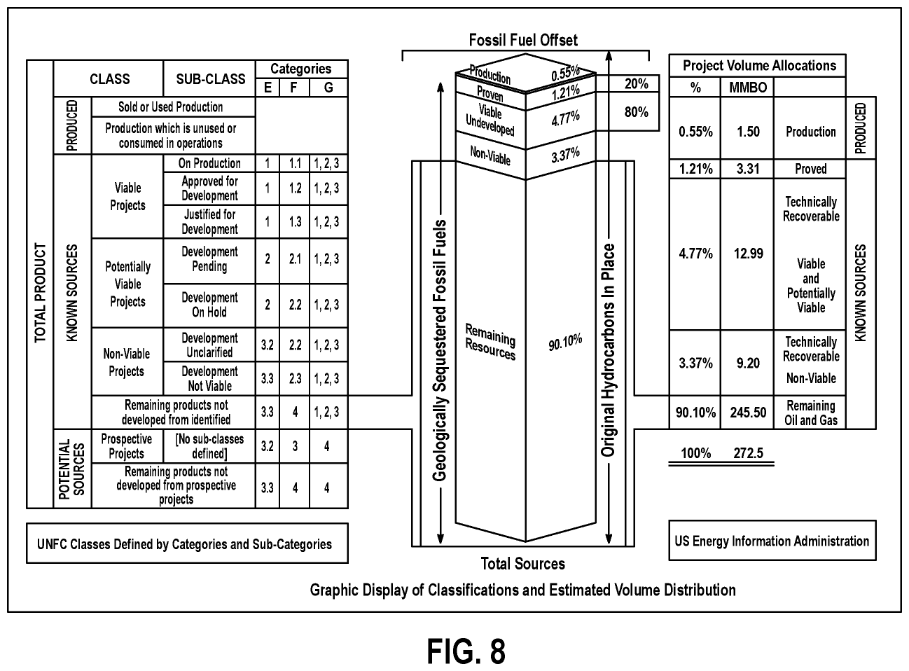

Another embodiment of estimating known oil or mineral deposits can be by processes such as described in FIG. 8. Deposits can be grouped into Viable, Potentially Viable, and Technically Recoverable Resources. Hydrocarbon volumes owned by a company are governed by SEC regulations for financial reporting, hydrocarbon volumes contained within a country are governed by technically recoverable viable and potentially viable resource deposits.

Viable: Development and operation are environmentally-socially-economically viable on the basis of current conditions and realistic assumptions of future conditions. All necessary conditions have been met (including relevant permitting and contracts) or there are reasonable expectations that all necessary conditions will be met within a reasonable timeframe and there are no impediments to the delivery of the product to the user or market. Environmental socio-economic viability is not affected by short-term adverse conditions provided that longer-term forecasts remain positive.

Potentially Viable: Development and operation are not yet confirmed to be environmentally-socially-economically viable but, on the basis of realistic assumptions of future conditions, there are reasonable prospects for environmental-socio-economic viability of the known resource deposit in the foreseeable future.

Technically Recoverable Resources: The EIA includes all the oil and gas that can be produced based on current technology, industry practice, and geologic knowledge. As technology develops, as industry practices improve, and as the understanding of the geology increases, the estimated volumes of technically recoverable known resources also expand.

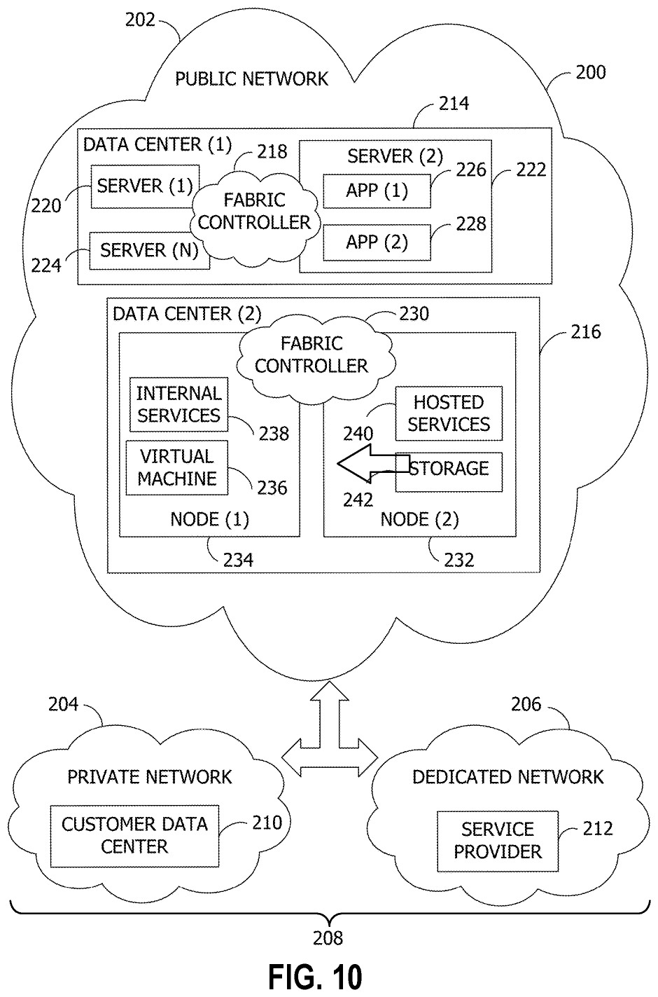

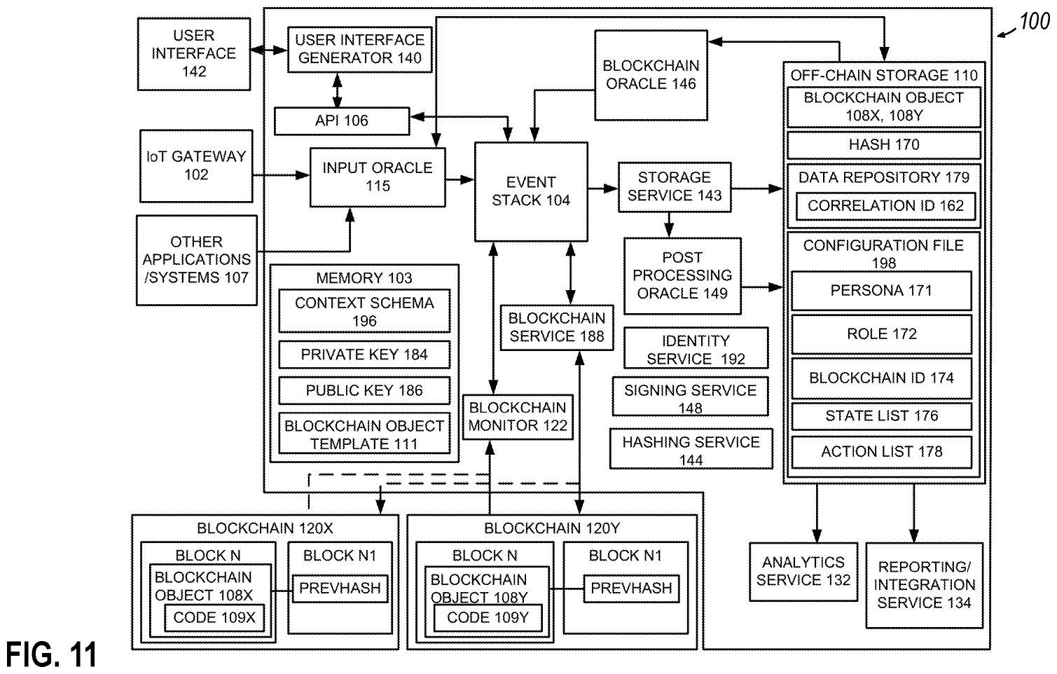

Referring now to FIGS. 9 through 11, an embodiment of an operating environment for the elements of a computing device, server or system 1 for implementing the present invention is shown. The operating environment for the system 1 is illustrated generally as computing device 100. Computing device 100 is but one example of a suitable operating environment and is not intended to suggest any limitation as to the scope of use or functionality of the disclosure. Neither should computing device 100 be interpreted as having any dependency or requirement relating to any one or combination of components illustrated. FIG. 11 below describes one example of the computing device 100. FIG. 11 includes components designed using the cloud architecture described in FIG. 10.

Components of the system 1 may be described and implemented in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Examples of the disclosure may be practiced in a variety of system configurations, including handheld devices, consumer electronics, general-purpose computers, specialty computing devices, etc. Aspects of the disclosure may also be practiced in distributed computing environments where tasks are performed by remote-processing devices that are linked through a communications network.

With continued reference to FIG. 9, computing device 100 includes a bus 161 that directly or indirectly couples the following devices: memory 103, one or more processors 163, one or more presentation components 164, input/output (I/O) ports 165, I/O components 166, and an illustrative power supply 167. Bus 161 represents what may be one or more busses (such as an address bus, data bus, or combination thereof). Although the various blocks of FIG. 9 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. Recognizing that such is the nature of the art, the diagram of FIG. 9 is merely illustrative of an example of a computing device that can be used in connection with one or more examples of the present disclosure. Distinction is not made between such categories as “workstation,” “server,” “laptop,” “handheld device,” etc., as all are contemplated within the scope of FIG. 9 and reference to “computer” or “computing device.”

Computing device 100 typically includes a variety of non-transitory computer readable media. By way of example, and not limitation, computer readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device 100. Computer storage media does not, however, include propagated signals. Rather, computer storage media excludes propagated signals. Any such computer storage media may be part of computing device 100.

Memory 103 includes computer storage media in the form of volatile and/or nonvolatile memory. The memory may be removable, non-removable, or a combination thereof. Examples of hardware devices include solid-state memory, hard drives, optical-disc drives, etc. Processors 163 read data from various entities such as memory 103 or I/O components 166. Memory 103 stores, among other data, one or more applications. The applications, when executed by the one or more processors, operate to perform functionality on the computing device. The applications may communicate with counterpart applications or services such as web services accessible via a network (not shown). For example, the applications may represent downloaded client-side applications that correspond to server-side services executing in a cloud. In some examples, aspects of the disclosure may distribute an application across a computing system, with server-side services executing in a cloud based on input and/or interaction received at client-side instances of the application. In other examples, application instances may be configured to communicate with data sources and other computing resources in a cloud during runtime, such as communicating with a cluster manager or health manager during a monitored upgrade or may share and/or aggregate data between client-side services and cloud services.

Presentation component(s) 164 present data indications to a participant or other device. Examples of presentation components include a display device, speaker, printing component, vibrating component, etc. I/O ports 165 allow computing device 100 to be logically coupled to other devices including I/O components 166. Illustrative components include a microphone, joystick, game pad, satellite dish, scanner, printer, wireless device, etc.

FIG. 10 shows an example of an architecture 200 of a cloud computing environment for one or more components of the system 100 (described in detail in FIG. 11). The one or more components of the system 100 may use one or more components shown in FIG. 10 to create one or more services described in further detail in FIG. 11. The one or more services of the system 100 may generate a blockchain object, deploy a blockchain object, interface with a blockchain object and manage a blockchain object. Architecture 200 should not be interpreted as having any dependency or requirement related to any single component or combination of components illustrated therein. Also, any number of nodes, virtual machines, data centers, role instances, or combinations thereof may be employed to achieve the desired functionality within the scope of embodiments of the present disclosure.

The distributed computing environment of FIG. 10 includes a public network 202, a private network 204, and a dedicated network 206. Public network 202 may be a public cloud, for example. Private network 204 may be a private enterprise network or private cloud, while dedicated network 206 may be a third-party network or dedicated cloud. In this example, private network 204 may host a customer data center 210, and dedicated network 206 may host an internet service provider 212. Hybrid cloud 208 may include any combination of public network 202, private network 204, and dedicated network 206. For example, dedicated network 206 may be optional, with hybrid cloud 208 comprised of public network 202 and private network 204.

Public network 202 may include data centers configured to host and support operations, including tasks of a generating, deploying, interfacing, and managing the blockchain object, according to embodiments of the current disclosure. It may be understood and appreciated that data center 214 and data center 216 shown in FIG. 10 an example of one implementation for accommodating one or more applications and is not intended to suggest any limitation as to the scope of use or functionality of embodiments of the present disclosure. Neither should data center 214 and data center 216 be interpreted as having any dependency or requester related to any single resource, combination of resources, combination of servers (e.g., server 220, server 222, and server 224) combination of nodes (e.g., nodes 232 and 234), or set of APIs to access the resources, servers, and/or nodes.

Data center 214 illustrates a data center comprising a plurality of servers, such as server 220, server 222, and server 224. A fabric controller 218 is responsible for automatically managing the servers and distributing tasks and other resources within the data center 214. By way of example, the fabric controller 218 may rely on a service model (e.g., designed by a customer that owns the modular application) to provide an interface on how, where, and when to configure server 222 and how, where, and when to place application 226 and application 228 thereon. In one embodiment, one or more role instances of a modular application may be placed on one or more of the servers of data center 214, where the one or more role instances may represent the portions of software, component programs, or instances of roles that participate in the blockchain object application manager application. In another embodiment, one or more of the role instances may represent stored data that is accessible to the blockchain object application manager.

Data center 216 illustrates a data center comprising a plurality of nodes, such as node 232 and node 234. One or more virtual machines may run on nodes of data center 216, such as virtual machine 236 of node 234 for example. Although FIG. 10 depicts a single virtual node on a single node of data center 216, any number of virtual nodes may be implemented on any number of nodes of the data center in accordance with illustrative embodiments of the disclosure. Generally, virtual machine 236 is allocated to role instances of a modular-application, or service application, based on demands (e.g., amount of processing load) placed on the modular-application. As used herein, the phrase “virtual machine” is not meant to be limiting, and may refer to any software, application, operating system, or program that is executed by a processing unit to underlie the functionality of the role instances allocated thereto. Further, the virtual machine 236 may include processing capacity, storage locations, and other assets within the data center 216 to properly support the allocated role instances.

In operation, the virtual machines are dynamically assigned resources on a first node and second node of the data center, and endpoints (e.g., the role instances) are dynamically placed on the virtual machines to satisfy the current processing load. In one instance, a fabric controller 230 is responsible for automatically managing the virtual machines running on the nodes of the data center 216 and for placing the role instances and other resources (e.g., software components) within the data center 216. By way of example, the fabric controller 230 may rely on a service model (e.g., designed by a customer that owns the service application) to provide user interface on how, where, and when to configure the virtual machines, such as virtual machine 236, and how, where, and when to place the role instances thereon.

As discussed above, the virtual machines may be dynamically established and configured within one or more nodes of a data center. As illustrated herein, node 232 and node 234 may be any form of computing devices, such as, for example, a personal computer, a desktop computer, a laptop computer, a mobile device, a consumer electronic device, server(s), and the like. In one instance, the nodes host and support the operations of the virtual machines, while simultaneously hosting other virtual machines carved out for supporting other tenants of the data center 216, such as internal services 238 and hosted services 240. Often, the role instances may include endpoints of distinct service applications owned by different customers.

Typically, each of the nodes includes, or is linked to, some form of a computing unit (e.g., a central processing unit, microprocessor, etc.) to support operations of the component(s) running thereon. As utilized herein, the phrase “computing unit” generally refers to a dedicated computing device with processing power and storage memory, which supports operating software that underlies the execution of software, applications, and computer programs thereon. In one instance, the computing unit is configured with tangible hardware elements, or machines, that are integral, or operably coupled, to the nodes to enable each device to perform a variety of processes and operations. In another instance, the computing unit may encompass a processor (not shown) coupled to the computer readable medium (e.g., computer storage media and communication media) accommodated by each of the nodes.

The role instances that reside on the nodes support the operation of service applications and may be interconnected via application programming interfaces (APIs). In one instance, one or more of these interconnections may be established via a network cloud, such as public network 202. The network cloud serves to interconnect resources, such as the role instances, which may be distributable placed across various physical hosts, such as nodes 232 and 234. Also, the network cloud facilitates communication over channels connecting the role instances of the service applications running in the data center 216. By way of example, the network cloud may include, without limitation, one or more local area networks (LANs) and/or wide area networks (WANs). Such networking environments are commonplace in offices, enterprise-wide computer networks, intranets, and the internet. Accordingly, the network is not further described herein.

With reference to FIG. 11, there is shown the system 101 that may create, deploy, and manage a first blockchain object 108X on a first blockchain 120X and a second blockchain object 108Y on a second blockchain 102Y that are correlated using a correlation id 162, according to an embodiment. The first blockchain object 108X and the second blockchain object 108Y may be collectively called blockchain objects. Similarly, the first blockchain 120X and the second blockchain 120Y may be collectively called blockchains. The term blockchains 120X and/or 120Y, may refer to either of the blockchains or both. The term blockchain objects 108X and/or 108Y may refer to either of the blockchain of the blockchain objects or to both. For example, FIG. 11 shows the first blockchain object 108X and the second blockchain object 108Y that may be created by the system 100 and may be deployed on the first blockchain 120X and the second blockchain 120Y respectively by the system 100.

As is further discussed below, the system 101 may also serve as an interface between an event, such as the creation or modification of a carbon credit, which may be received and queued for processing in an event stack 104, and the first blockchain object 108X, the second blockchain object 108Y or both. The system 101 may also facilitate and control interactions with the first blockchain object 108X, the second blockchain object 108Y or both by a participant or another system attempting to interact with the blockchain object 108. For example, the blockchain object 108X may be accessible only to a participant with a persona of a buyer, while the blockchain object 108Y may be accessible to a participant with a persona of a seller. The system 101 may use the correlation id 162 to synchronize the blockchain object 108X on the first blockchain 120X and the blockchain object 108Y on the second blockchain 120Y. Also, the system 101 allows services, which may be incorporated in the system 101, to process events and other information pertaining to the blockchain objects 108X and 108Y. A service may refer to a software functionality or a set of software functionalities that different systems or users or other software functionalities can reuse and may include policies that control its usage. It should be understood that the system 101 may include additional components other than shown and that one or more of the components described herein may be removed and/or modified without departing from a scope of the system 101.

In the system 101, cryptlets or oracles may be used to enable the processing of events on the event stack or for processing data generally on the system 101 or for processing events received from the blockchain and any source of events internal to the system 101 or external to the system 101. Cryptlets and oracles may include machine-readable instructions that may be executed on the blockchain or in secure enclaves outside the blockchain. The cryptlets and oracles may execute their machine-readable instruction in a secure enclave where the data is protected during execution of the code. In an example, components 115, 146 and 149 of the system 101 may be embodied as a cryptlet or an oracle. The system 101, may use cryptlets or oracles to perform the services provided by the input service 115, blockchain oracle 146 and the post processing service 149 or other services.

The event stack 104 may also interface with an Application Programming Interface (API) 106 that invokes generating a user interface 142 through a user interface generator 140. The user interface generator 140 may generate the user interface 142 to receive interactions from a participant. The system 101 may treat the interaction received from the participant as an event. In an example, the user interface 142 may be generated on a remote computer. The user interface 142 may be displayed on a screen in a web browser. The user interface generator 140 may queue events received from participants via the user interface 142 in the event stack 104 through the API 106.

Also, the input service 115 may receive an event from other systems. For example, the input service 115 may receive an event from other application systems 107. The input service 115 may also retrieve events from off-chain storage 110 and other services, as is further discussed below.

In an example, the API 106 may allow the system 101 to receive events at the event stack 104 from the user interface 142. The events may in examples identify a participant (e.g., a participant), provide authorization to interact with a blockchain object, identify a list of currently associated blockchain objects, generate new blockchain objects, provide documents for hashing, uploading to a blockchain, provide documents for storage on the off-chain storage 110, details of a blockchain object such as owner, the participants allowed to interact, offer price, etc. Although the user interaction is described with reference to the user interface 142, the system 101 may receive events from a participant through the command line, a holographic interface, a voice recognition system, from other systems 107 and the like.

In an example, the input service 115 in association with the API 106 may provide an interface to websites, mobile devices, and other systems to allow access to blockchains 120X, 120Y and/or blockchain objects 108X, 108Y. The system 101 may thus provide a service that may allow interaction between the blockchain and participants using the API. For example, a mobile application may use the API to allow participants access to blockchains 120X, 102Y.

Examples of services that may process the events queued by the event stack 104 may include a storage service 143, a blockchain service 188, a blockchain monitor 122, an analytics service 132, an integration service 134, etc., which are further discussed below. Also, the system 101 may process events, and determine whether to alter the state of blockchain object 108X and/or 108Y based on the events, as is further discussed below.

The storage service 143 may store the events in off-chain storage 110. Off-chain storage 110 refers to storage outside the blockchain 120X, 120Y. Examples of the off-chain storage 110 include databases, cloud storage services, data lakes, and the like. In an example, the system 101 may store events locally on a hard drive, and the storage service 143 may process the events before storing the events in the off-chain storage 110. In an example, the system 101 may use a post processing service 149 to process events before storing the events in the off-chain storage 110.

The storage service 143 may maintain a synchronized version of events on the blockchain 120X, 120Y in the off-chain storage 110. For example, the storage service 143 may generate a hash of a new event that occurs on the first blockchain 120X or the second blockchain 102Y and store the event and the hash in the off-chain storage 110. Also, the system 101 may deploy a message blockchain object to the other blockchain with the new event addressed to the blockchain object on the other blockchain to synchronize the events on the two blockchains. The storage service 143 may generate a hash of each blockchain object on blockchains 120X,120Y when new objects are added to blockchains 120X, 120Y. The hashing service 144 may hash the blockchain object (i.e., event received from blockchains 120X and/or 120Y) from the event stack 104 before storing the hash and the transaction to the off-chain storage 110. The hashing service 144 may use an SHA (Secure Hashing Algorithm) or any suitable cryptographic function to generate a hash of an input, such as an event. Also, the hashing service 144 may be used to hash an event, such as a blockchain object deployed on blockchains 120X and/or 120Y.

For example, when the first blockchain object 108X is deployed on the first blockchain 120X, the first blockchain object 108X is hashed using the hashing service 144, to determine a hash 170 of the blockchain object 108X. The storage service 143 may store the first blockchain object 108X and the hash 170 in the off-chain storage 110. Hashes may be used to identify blockchain objects stored in the off-chain storage 110. Hashes may also be used to verify whether the blockchain objects stored in the off-chain storage 110 are the same as those on the blockchain 120X and/or 120Y. For example, the system 101 may compare the hashes of the same blockchain object stored on the first blockchain 120X and the off-chain storage 110 to verify that the two objects are identical and has not been tampered with. In an example, the system 101 may store the hash 170 of the first blockchain object 108X to the blockchain 120X instead of deploying the first blockchain object 108X. The storage service 143 stores the hash 170 and the first blockchain object 108X in the off-chain storage 110. Storing the hash of the first blockchain object 108X instead of the first blockchain object 108X itself on the first blockchain 120X may allow the system 101 to execute the first blockchain object 108X in a secure enclave in response to events on the first blockchain 120X and/or on the second blockchain 120Y and deploy the new hash (e.g., the first blockchain object 108X may have a changed state after execution) of the first blockchain object 108X after execution on the first blockchain 120X. Although described with reference to the first blockchain object 108X and the first blockchain 120X, the storage service 143 may perform similar operations on the second blockchain object 108Y deployed on the second blockchain 120Y

In an example, the storage service 143 may store information on the off-chain storage 110 that may not be placed on blockchains 120X and/or 120Y due to the immutability of blockchains 120X and/or 120Y. For example, the personally identifiable information may be stored in the off-chain storage 110.

The event stack 104 may also receive an event (e.g., a blockchain object on a blockchain) from the blockchain monitor 122. For example, the blockchain monitor 122 monitors block updates, i.e., blocks as they are added to blockchains 120X and/or 120Y. A block update may be a new block. The blocks may include files containing blockchain objects. The blockchain monitor 122 may retrieve a new block after it is posted to the first blockchain 120X, identify a plurality of events in a block update (i.e., a new block) in the first blockchain 120X, and queue the plurality of events on the event stack 104 for processing. In an example, the blockchain monitor 122 may monitor the first blockchain 120X generated on a peer-to-peer network of nodes mining the first blockchain 120X to generate a consensus on the new block with blockchain objects external to the system 101. The blockchain monitor 122 may receive a new block on the first blockchain 120X published by a node of the peer-to-peer network external to the system 101. The peer may publish the new block after the node generates the new block based on a consensus protocol of the first blockchain 120X. Examples of consensus protocols for the first blockchain 120X may include proof of work, proof of stake, directed acyclic graph or the like. The blockchain monitor 122 may identify blockchain objects on the new block. In an example, the blockchain monitor 122 may generate an event for each blockchain object on the new block. Events may be queued on the event stack 104 from the blockchain monitor 122. The events may also be stored in the off-chain storage 110 by the storage service 143 as described above.

In an example, the blockchain monitor 122 may receive a block update with a change in state for the first blockchain object 108X. The blockchain monitor 122 may place the event with the change in state of the first blockchain object 108X on the event stack 104. In another example, the blockchain object 108X may depend on the system 101 to change its state (e.g., the blockchain object 108X may not be executed/supported on the blockchain 120X). The blockchain monitor 122 may receive a block update with a message blockchain object addressed to the first blockchain object 108X. The blockchain monitor 122 may place the message event on the event stack 104 for other services in the system 101.

Although described with reference to the first blockchain object 108X and/or the first blockchain 120X, the blockchain monitor 122 may provide similar functionality to other blockchain objects and/or blockchains

The event stack 104 may also interface with a blockchain service 188 that writes events to the first blockchain 120X. The blockchain service 188 may allow the system 101 to deploy selected events from the event stack 104 to the first blockchain 120X. For example, the system 101 may receive an event (e.g., an interaction from a participant) through the user interface 142 to deploy the first blockchain object 108X. The blockchain service 188 may then transmit the first blockchain object 108X to a node on a peer-to-peer network of nodes mining the first blockchain 120X. The node may then generate a new block for the first blockchain 120X based on the consensus protocol of the first blockchain 120X. As described above, the storage service 143 may also store the first blockchain object 108X in the off-chain storage 110. The storage service 143 may also store hash 170 of the first blockchain object 108X in the off-chain storage 110.

In an example, the blockchain service 188 may deploy the first blockchain object 108X to the first blockchain 120X. Although described with reference to the first blockchain object 108X and/or the first blockchain 120X, the blockchain service 188 may provide similar functionality to other blockchain objects and/or blockchains. For example, the blockchain service 188 may deploy the second blockchain object 108Y to the second blockchain 120Y.

In another example, the blockchain service 188 may be blockchain agnostic. For example, the blockchain service 188 may deploy blockchain objects 108X and/or 108Y to two or more blockchains 120X and/or 120Y. As used herein 108X and/or 108Y means the first blockchain object 108X and/or the second blockchain object 108Y.

The storage of events on off-chain storage 110 allows analytics services 132 and reporting and integration service 134 to use the data without additional steps to obtain blockchain object data from the first blockchain 120X, the second blockchain 120Y and/or both. Examples of the analytics service 132 may include Azure™ Data Lake analytics, Azure™ Stream Analytics, machine learning analytics and the like. Also, the off-chain storage 110 augments the first blockchain object 108X with contextual information about the first blockchain object 108X not available on the first blockchain 120X. The contextual detail is available to services on the system 101 including services that are blockchain agnostic using the configuration file 198, which describes relationships between users, their roles, actions available to them, parameters of the blockchain object and the like. The reporting/integration service 134 may allow integration of the blockchain objects stored in the off-chain storage 110, the contextual details augmented by the configuration file 198 and a data repository 179 storing the values of the contextual information in accordance with the type information in the configuration file 198 with services that are not blockchain aware. The services that are not blockchain aware may access the events from the first blockchain 120X, the second blockchain 120Y or both from the data repository 179 storing all the values along with contextual information.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for converting hydrocarbon bearing mineral deposits to carbon offset credits and allowing for the trading of such carbon offset credits, the system comprising:
a database configured to receive location and valorization information regarding hydrocarbon bearing mineral deposits, the database configured to maintain a map of all record mineral deposits, the database configured to verify mineral deposits with a creator of carbon credits, hydrocarbon conservancy deeds and to assign respective carbon credits to a mineral deposit; and
a blockchain configured to allow nodes to trade the carbon offsets associated with the hydrocarbon bearing mineral deposits;
wherein the database is further configured to associate a mineral deposit with a node of the blockchain, and further configured to update the map when a mineral deposit is traded to a new owner.

2. The system of claim 1 wherein the blockchain is configured to trade the carbon offsets via smart contracts.

3. The system of claim 1 wherein the database is configured to use ArcGis-based mapping.

4. The system of claim 1 wherein the database is configured to use the oil climate index (OCI) or other LCA as appropriate to the hydrocarbon deposit.

5. The system of claim 1 wherein the database is configured to use the Oil Production Greenhouse Gas Emissions Estimator (OPGEE).

6. The system of claim 1 wherein the database is configured to use the Petroleum Refinery Life-Cycle Inventory Model (PRELIM).

7. The system of claim 1 wherein the database is configured to use the Oil Products Emissions Module (OPEM).

8. The system of claim 1 wherein the database is configured to use data comprising one or more of: oil samples, drilling and completion techniques, workovers, and distances.

9. A method of creating and trading carbon credits, comprising:
performing an analysis of a hydrocarbon deposit comprising determining a size and a production risk value;
convert the hydrocarbon deposit into unique serialized registered carbon credits;
associate the unique serialized registered carbon credits with one or more nodes on a blockchain; and
allow the trading of the carbon credits via the blockchain.

10. The method of claim 9 further comprising obtaining regulatory or NGO approval of the analysis of the hydrocarbon deposit.

11. The method of claim 9 wherein the blockchain is configured to trade the carbon offsets via smart contracts or tokens.

12. The method of claim 9 wherein the database is configured to use ArcGis-based mapping.

13. The method of claim 9 wherein the database is configured to use the oil climate index (OCI) or other LCA as appropriate to the hydrocarbon deposit.

14. The method of claim 9 wherein the database is configured to use the Oil Production Greenhouse Gas Emissions Estimator (OPGEE).

15. The method of claim 9 wherein the database is configured to use the Petroleum Refinery Life-Cycle Inventory Model (PRELIM).

16. The method of claim 9 wherein the database is configured to use the Oil Products Emissions Module (OPEM).

17. The method of claim 9 wherein the database is configured to use data comprising one or more of: oil samples, drilling and completion techniques, workovers, and distances.

18. A system for creating and trading carbon offset credits, the system operable to convert hydrocarbon bearing mineral deposits to carbon offset credits, the system comprising:
a server receiving survey data on the hydrocarbon bearing mineral deposit and performing an analysis of the hydrocarbon deposit to determine a size and a production risk value and a value of offsetable carbon;
a database in communication with the server, the database containing location and valorization information regarding hydrocarbon bearing mineral deposits, the database configured to maintain a map of all record mineral deposits, the database configured to verify mineral deposits with a creator of carbon credits and to assign respective carbon credits to a mineral deposit using the server; and
a blockchain server in communication with the server and the database and configured to allow nodes to trade the carbon offsets associated with the hydrocarbon bearing mineral deposits;
wherein the blockchain server is further configured to associate a mineral deposit with a node of the blockchain.

19. The system of claim 18 wherein the blockchain server is configured to trade the carbon offsets via smart contracts or tokens.

20. The system of claim 18 wherein the server and database determine carbon credits using data comprising one or more of: oil samples, drilling and completion techniques, workovers, and distances.
